(19) United States
(12) Patent Application Publication
(10) Pub. No.: US 2002/0055934 A1
(43) Pub. Date: May 9, 2002

(54) Dynamic management and organization of media assets in a media player device

(76) Inventors: Kenneth O. Lipscomb, Marietta, GA (US); John B. Petritis, Lawrenceville, GA (US); Richard D. Robison, Decatur, GA (US); Kelly I. Morrison, Atlanta, GA (US); Michael D. Hirsch, Atlanta, GA (US); Eric N. Muntz, Marietta, GA (US)

Correspondence Address: D. Andrew Floam, NEEDLE & ROSENBERG, P.C., The Candler Building, Suite 1200, 127 Peachtree Street, N.E., Atlanta, GA, 30303-1811, US

(21) Appl. No.: 09/768,932

(22) Filed: Jan. 24, 2001

Related U.S. Application Data
(60) Provisional application No. 60/177,700, filed on Jan. 24, 2000.

(51) Int. Cl. G06F 17/00; G06F 7/00; G06F 17/24; G06F 17/21; G06F 15/00; G09G 5/12

(52) U.S. Cl. 707/104.1; 700/94; 707/500.1

(57) ABSTRACT

A system and method for the management and organization of media assets involving nested keylists. A keylist is created comprising an ordered sequence of items, each item referencing either to a media asset or a keylist. User selections of reference data for media assets identified from a plurality of available media assets to be assigned to each keylist.

This application claims priority to U.S. Provisional Application No. 60/177,700 filed Jan. 24, 2000, entitled “Dynamic Management And Organization Of Media Assets In A Universal Media Player,” the entirety of which is incorporated herein by reference.

### BACKGROUND OF THE INVENTION

In order to implement an infotainment device that can replace a user's entire physical multimedia library, the device must be capable of keeping track of and referencing a large number of media assets. The present invention provides a system and method for organizing the media assets of a media player device.

### SUMMARY OF THE INVENTION

The present invention is directed to the management and organization of media assets in a media player device. These aspects of the invention are accomplished by way of a nested keylist media asset creation and usage processes. A keylist comprises an ordered sequence of items, each item referencing either a media asset or a keylist.

### BRIEF DESCRIPTION OF THE DRAWINGS

FIG. 1 is a block diagram of the keylist architecture according to the invention.

FIG. 2 is a block diagram of a media player device that uses the keylist architecture according to the invention.

FIG. 3 is a flowchart illustrating how to build a keylist.

### DETAILED DESCRIPTION OF THE INVENTION

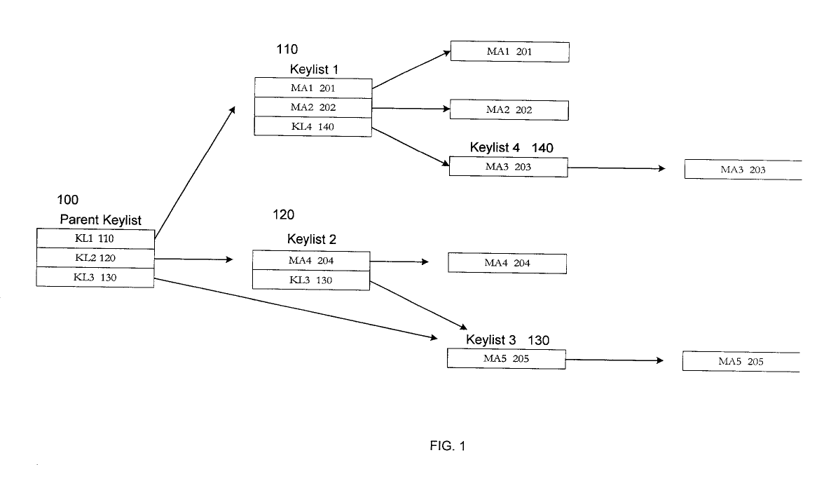

The present invention is described with initial reference to FIG. 1. Referring to FIG. 1, to efficiently control the playback or usage of media assets it is desirable to group and manipulate a large number of media asset objects. This task is accomplished by way of a nested keylist architecture. Keylists are playback or usage data list structures that store reference information pertaining to media assets. A keylist is an ordered sequence of items, each item referencing either a media asset or a keylist. Thus, one keylist may refer to another keylist, thereby providing a nested data structure. The media assets are locally and/or remotely stored for usage on a media player device. A subkeylist is any keylist referenced by another keylist. The implementation of a keylist enables a media player device operator to command, in a quick and efficient manner, a media player device to play predetermined lists of media assets.

The media assets referred to herein are digital media objects that may embody various types of audio, video and/or other types of multimedia data. Examples of media assets include but are not limited to tracks on a CD or DVD, stored digital audio or video assets (such as MP3 files, QuickTime files, etc.), streaming audio or video assets, interactive animation assets and games with audio and video content.

An advantage of a dynamic media organization invention such as the keylist is the ability to group different types of media assets for playback in sequence with one another. The hierarchical structure of the keylist allows the media player operator to quickly traverse a library of media assets. This playlist function may be implemented by the creation of a parent keylist 100 through which media assets are accessed by way of embedded keylists and subkeylists. A parent keylist is an organization tool for keylists. FIG. 1 shows an example of a keylist architecture that is composed of five media assets (MA) (MA1 201, MA2 202, MA3 203, MA4 204 and MA5 205), a parent keylist 100, and keylists (KL) (KL1 110, KL2 120, KL3 130, KL4 140). KL4 is an example of a keylist that is a subkeylist with respect to KL1. Similarly, KL3 is an example of a keylist that is a subkeylist with respect to KL2. In this example, KL3 is a keylist that stands its own in the parent keylist, and also is a subkeylist with respect to KL2. It should be noted that each keylist may comprise a single media asset or an ordered sequence of a plurality of media assets. Any of the media assets listed may be located by beginning a search with the parent keylist 100 and following the appropriate references to the desired asset. The media asset MA3 203 may be located by beginning with the parent keylist 100, following the keylist reference to KL1 110 and then following KL1's 110 reference to KL4 140 and then following KL4's 140 reference to MA3 203.

Playback or usage of a keylist is such that when KL1 is invoked, media assets MA1, MA2 are used or executed in that sequence. Then, KL4 is invoked to use MA3. If the entire parent keylist 100 is invoked, then the KL2 is invoked such that MA4 is used, followed by KL3 which will cause the usage of MA5. Finally, KL3 is invoked again to use MA5.

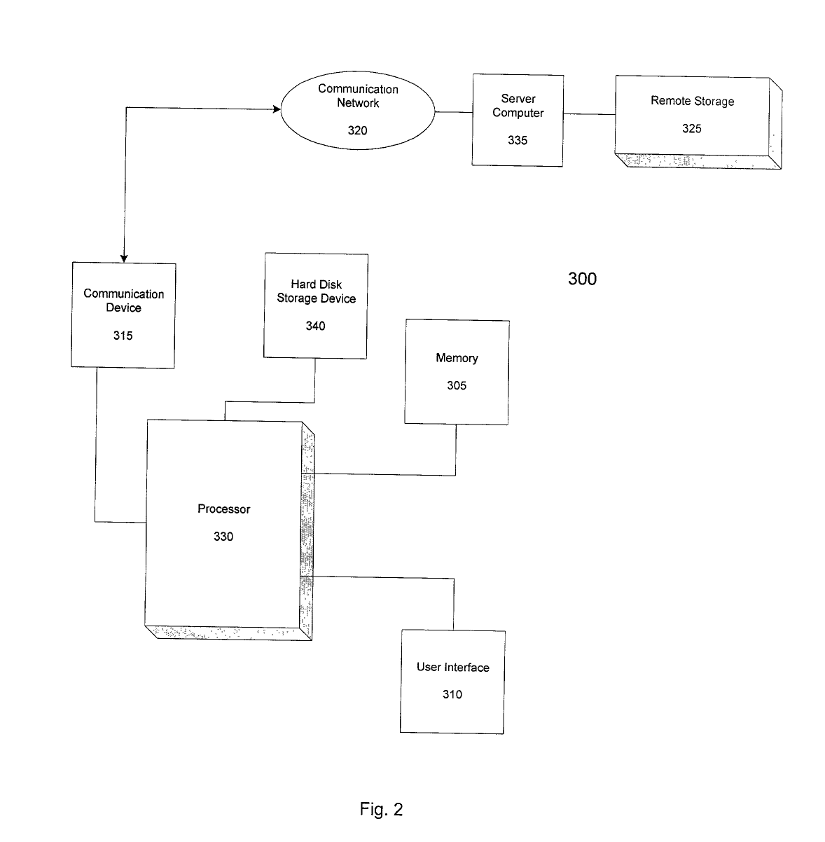

FIG. 2 illustrates an example of a media player device 300 with which the keylist architecture shown in FIG. 1 may be used. A media player device 300 is a device that enables a user to play a digital media asset. The media player device 300 may be a home consumer device that connects to a television or other monitor as well as a home stereo (amplifier/tuner, etc.) which in turn is connected to speakers, a personal computer (PC) (laptop or desktop), a vehicle-based electronic device, a portable media player device, or a wireless electronic device. An example of still another type of media player is a cable set-top box.

Briefly, a media player device 300 comprises a processor 330 that executes a media playback software application program (or alternatively hardware) to enable a user to play or use a digital media asset, such as music, video, games, etc. The media player device 300 may comprise a memory 305, user interface 310, a processor 330 and a communication device 315. The media player device 300 may comprise additional hardware that is dedicated to the processing of audio and video media asset data. The communication device 315 of the media player device may be linked to a communication network 320, such a link may be facilitated by way of a modem, etc. Such a link would allow for the media player device 300 to access a server computer 335 by way of a communication network 320 (such as the Internet) in order to obtain media assets that are stored on a remote storage unit 325 (the remote storage unit 325 may be a media player device 110). The memory 305 of the media player device 300 stores reference data pertaining to local and remotely stored media assets. User interface functions of the system may be realized by way of but not limited to a graphic user interface, keypad, touch pad, touch screen display, a mouse selector or voice recognition technology.

Generally, the media player device 300 is the size of a CD/DVD Player and provides for both audio and video output, though its size may vary with specific applications. The audio output may require an amplifier to drive speakers, or an amplifier may be included within the device. Video is directed to a television or monitor. The media player device 300 receives its media assets via broadband demand download or stream, traditional phone line download or stream from the server computer and/or other media partners. The media player device 300 is also able to download content and information from other Internet web sites through an embedded browser interface. Moreover, the media player device 300 can playback locally stored media assets such as CDs, DVDs, or other physical media as well as media assets stored within the media player device's memory 305. Further details of a media player device of the type shown in FIG. 2 are disclosed in the commonly assigned PCT Application No. PCTIUS00/27564, filed Oct. 5, 2000, the entirety of which is incorporated herein by reference.

The server computer 335 (or a group of server computers) is addressable for example by a URL via the World Wide Web and functions to allow for the storage, stream and download of media assets to a media player device 300. The server computer 335 provides connections to other source sites, such as sources of streaming Internet radio providers. The server computer 335 allows for synchronization and replication of a user's licensed assets with each of the user's media player devices 300. The server computer 335 may be accessible directly from a media player device 300 and may provide a customizable interface or view to each user, if desired.

Some or all of the user's licensed assets are catalogued and stored by the master media library database in the server computer 335. (It should be understood from the foregoing description that the media player device 300 itself has storage capability to locally store assets as described in the foregoing.)

Features of a media player device include: viewing as text the keylist listing, small icon or large icon views of a graphical keylist representation; dragging and drop building of keylist; computing total playing time for keylist events; looping keylist; playing with scan mode to listen to “x” seconds of a song or video of a keylist; and the initiation of a random playback of media assets that are contained within a keylist. The subsequent keylist data is incorporated into the database of the media player device.

The control interface for the media player device may be a user interface, such as graphic and character displays that are representative of: media asset title listings, media asset playtime lengths, media list number, media artist/creator and any other database information that an operator may find useful in building keylists.

In one embodiment, the operator generates a keylist by having the media player ascertain what media assets are available for access. At the request of the operator, the media player device displays a listing of the media assets available. The media player device has access to media assets that are stored locally and at the remote storage 325. A media player device may have a display that displays to a user those media assets available locally and/or on the remote storage 325 and providing the operator with specific references indicating where the media asset is stored. A keylist may store references to a media assets that are stored locally and/or remotely (and a combination thereof).

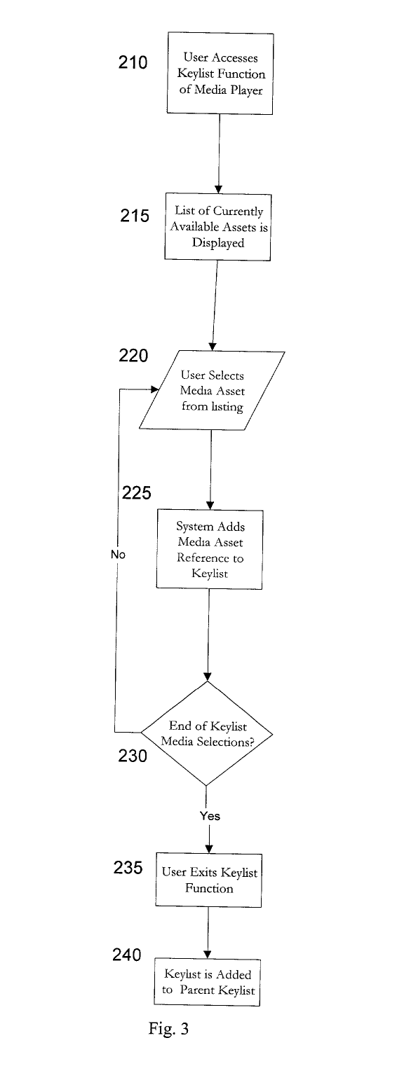

Referring to FIG. 3, a process for building and using the keylist architecture is described. In step 210 the user accesses the play list function of the media player device, and in step 215 a listing of the media assets of the system are displayed, providing the operator with a visual or other indicator of the available media assets. After reviewing the listing of available media assets, the operator may select the assets to be added to a personal keylist in step 220. In step 225, upon the selection of a media asset, the media player device adds the selection's reference data to the current keylist that is either being built or edited. At the end of the media asset selection process, the operator exits the media player's keylist function in step 235 and the keylist may be numbered and added to a parent keylist in step 240 if the operator chooses to create a parent keylist to keep track of multiple keylists. At this point, an operator may choose to playback or use media assets according to the sequences established by the nested keylist architecture.

The operator is in control of the type of media asset that is chosen, the order that the assets will be played back in, the length of a keylist and the relationship between keylists. The operator may at this time and at a subsequent time, add or delete media assets from a keylist or change the order of the playback listing of the keylist.

It should be understood that software to execute the keylist architecture described herein may reside locally on the media player device for execution by the processor of the media player device or remotely on the server computer. In the latter case, the media player device may invoke the keylist function on the server computer and the reference data for the keylist is stored and executed by the server computer in order to select (and transmit if necessary) the appropriate asset in the appropriate sequence for usage by the media player device.

As will be recognized by those skilled in the art, the innovative concepts describe in the present application can be modified and varied over a wide range of applications. Accordingly, the scope of patented subject matter should not be limited to any of the specific exemplary teachings describe herein.

What is claimed is:

1. A method for the management and organization of media assets, comprising the steps of:
creating a keylist comprising an ordered sequence of items, each item referencing either a media asset or a keylist; and
receiving user selections of reference data for media assets identified from a plurality of available media assets to be assigned to each keylist.

2. The method of claim 1, and further comprising the step of creating a parent keylist that comprises an ordered sequence of one or more keylists.

3. The method of claim 2, and further comprising the step of utilizing the media assets in accordance with the sequence of the parent keylist.

4. The method of claim 1, wherein the step of receiving comprises receiving user selections of reference data for media assets stored locally and/or remotely from a device on which the media assets are to be used.

5. The method of claim 1, wherein the media assets may comprise one or more selected from the group consisting of: audio assets, video assets, streaming audio or video assets and interactive software.

6. The method of claim 1, and further comprising utilizing items within a keylist in a random sequence.

7. A media player device comprising:
memory that stores reference data identifying a plurality of media assets;
a user interface that receives user input;
processor coupled to the memory and to the user interface, wherein the processor is responsive to user input via the user interface to execute a process to:
(i) create a keylist comprising an ordered sequence of items, each item referencing either a media asset or a keylist; and
(ii) receive user selections of reference data for media assets identified from a plurality of available media assets to be assigned to each keylist.

8. The device of claim 7, wherein the memory stores reference data for media assets stored locally and/or remotely from the device.

9. The device of claim 7, wherein the processor is programmed to select a media asset selected from the group consisting of: audio assets, video assets, streaming audio or video assets and interactive software.

10. The device of claim 7, wherein the processor utilizes items in a keylist in a random sequence.

11. The device of claim 7, wherein the processor is programmed to create a parent keylist comprising an ordered sequence of one or more keylists.

12. The device of claim 11, wherein the processor is programmed to execute usage of media assets in accordance with the sequence of the parent keylist.

13. A machine-readable medium having stored thereon data representing sequences of instructions, said sequences of instructions which, when executed by a processor, cause said processor to:
(i) create a keylist comprising an ordered sequence of items, each item referencing either a media asset or a keylist; and
(ii) receive user selections of reference data for media assets identified from a plurality of available media assets to be assigned to each keylist

14. The machine-readable medium of claim 13, and further comprising data representing instructions which when executed by a processor causes the processor to create a parent keylist comprising an ordered sequence of one or more keylists.

15. The machine-readable medium of claim 13, and further comprising data representing instructions which when executed by a processor causes the processor to execute usage of media assets in accordance with the sequence of the parent keylist.

16. A method for the management and organization of media assets, comprising the steps of:
creating a keylist comprising an ordered sequence of the following items: (1) an ordered sequence of a plurality of media assets and (2) one or more keylists; and
receiving user selections of reference data for media assets identified from a plurality of available media assets to be assigned to a keylist.
